(19) United States
(12) Patent Application Publication
(10) Pub. No.: US 2026/0161358 A1
(43) Pub. Date: Jun. 11, 2026

(54) ACCELERATOR FOR PROCESSING FLOATING POINT OPERATIONS USING INTEGER OPERATOR AND ITS OPERATION METHOD

(71) Applicant: SEOUL NATIONAL UNIVERSITY R&DB FOUNDATION, Seoul (KR)

(72) Inventors: Jae-Joon KIM, Seoul (KR); Jehun LEE, Seoul (KR)

(21) Appl. No.: 19/181,987

(22) Filed: Apr. 17, 2025

(30) Foreign Application Priority Data
Apr. 18, 2024 (KR) 10-2024-0051845
Jul. 9, 2024 (KR) 10-2024-0090012

(51) Int. Cl. G06F 7/544; G06F 5/01; G06F 7/485; G06F 7/487; G06F 9/50

(52) U.S. Cl. CPC G06F 7/5443; G06F 5/012; G06F 7/485; G06F 7/4876; G06F 9/5027

(57) ABSTRACT

An operation accelerator for processing floating-point operations using an integer operator, according to one aspect, comprises: a first exponent decoder configured to determine whether an input data encoded with an exponent is an outlier based on a bias bit of the input data, and to perform pre-alignment processing that shifts a mantissa of the input data based on the bias bit; a second exponent decoder configured to determine whether weight data encoded with an exponent is an outlier based on a bias bit of the weight data, and to perform pre-alignment processing that shifts a mantissa of the weight data based on the bias bit; and a computation unit configured to perform multiplication and accumulation operations in integer arithmetic on the mantissa of the input data output from the first exponent decoder and the mantissa of the weight data output from the second exponent decoder.

### CROSS-REFERENCE TO RELATED APPLICATION

This application claims the benefit under 35 USC 119(a) of Korean Patent Application Nos. 10-2024-0051845 filed on Apr. 18, 2024 and 10-2024-0090012 filed on Jul. 9, 2024 in the Korean Intellectual Property Office, the entire disclosures of which are incorporated herein by reference for all purposes.

### BACKGROUND

### 1. Field

The present invention relates to an accelerator for processing floating point operations using an integer operator, and an operation method thereof.

### 2. Description of the Related Art

Large-scale language models based on Transformers and conventional CNNs (Convolutional Neural Networks) for image processing repeatedly perform matrix-multiplication operations, and various accelerator architectures have been developed to support this.

In particular, many accelerator architectures exist that support quantized integer operations to accelerate neural networks. For example, techniques that support BFP (Block Floating Point) operations, which pre-align floating point values to produce neural network results similar to those obtained using floating point formats, are known. However, such techniques require software support to handle newly emerging neural networks, and it remains uncertain whether they can be applied consistently.

Additionally, techniques such as FMA (Fused Multiply-Add), which combines multiplication and accumulation operations, are known to reduce the burden of additional circuits for rounding or normalization in floating point multiply-accumulate operations. While these methods offer the advantage of reducing circuit complexity, they still occupy significant chip area and processing time within the overall floating point unit.

The present invention aims to solve the limitations of conventional techniques by classifying weight data and activation values into normal values and outliers, and executing operations for both types using multipliers of the same size. This increases the activation rate of the operator and minimizes system complexity.

### PATENT LITERATURE

(Patent Document 1) Korean Unexamined Patent Publication No. 2023-0094627 (Title of Invention: Floating Point Operation Device and Method Using In-Memory Computing)

### SUMMARY

The present invention aims to provide an accelerator and its operation method for performing floating-point operations using an integer operator to address the aforementioned problems.

However, the technical problems to be achieved by the present embodiment are not limited to those described above, and other technical problems may exist.

As a technical means for achieving the above-described technical problems, an accelerator for processing floating-point operations using an integer operator according to one aspect of the present invention includes: a first exponent decoder configured to determine whether an input data encoded with an exponent is an outlier based on a bias bit thereof, and to perform pre-alignment processing by shifting a mantissa of the input data according to the bias bit; a second exponent decoder configured to determine whether a weight data encoded with an exponent is an outlier based on a bias bit thereof, and to perform pre-alignment processing by shifting a mantissa of the weight data according to the bias bit; and a computation unit configured to perform multiplication and accumulation operations in integer arithmetic on the mantissa of the input data output from the first exponent decoder and the mantissa of the weight data output from the second exponent decoder.

Also, a method of exponent encoding a floating-point number according to another aspect of the present invention includes: (a) classifying the number as a normal value when the exponent of the floating-point number falls within a predetermined reference range, and calculating a bias bit that represents the difference between the exponent and the shared exponent; and (b) outputting, as an encoded result, a combination of the shared exponent, sign bit, the bias bit, and the mantissa of the number classified as a normal value, wherein the shared exponent corresponds to the minimum value among the exponents included in the reference range.

In addition, an operation method of an accelerator for processing floating point operations using an integer operator according to another aspect of the present invention includes: (a) a first exponent decoding step of checking whether the exponent-encoded input data is an outlier based on the bias bit, and performing a pre-alignment process of shifting the mantissa of the input data according to the bias bit; (b) a second exponent decoding step of checking whether the exponent-encoded weight data is an outlier based on the bias bit, and performing a pre-alignment process of shifting the mantissa of the weight data according to the bias bit; and (c) performing a multiplication operation and an accumulation operation through integer operations on the mantissa of the input data output from the first exponent decoding and the mantissa of the weight data output from the second exponent decoding.

According to the aforementioned solution, it is possible to perform multiplication and accumulation operations on floating-point numbers using an integer operator, thereby reducing the area of the operation accelerator and improving energy efficiency. In particular, by classifying normal values and outliers based on the exponent distribution of floating-point numbers and performing exponent encoding by separating the shared exponent and bias bit for normal values, it becomes possible to process floating-point numbers using integer operations.

### BRIEF DESCRIPTION OF THE DRAWINGS

FIG. 1 illustrates an operation accelerator according to an embodiment of the present invention.

FIG. 2 is a diagram for explaining the distribution of normal values and outliers for weights and activation values in the present invention.

FIGS. 3 and 4 are diagrams for explaining the exponent encoding process of each number in the present invention.

FIG. 5 illustrates a process of performing exponent decoding on exponent-encoded numbers according to an embodiment of the present invention.

FIG. 6 illustrates a detailed configuration of the computation unit according to an embodiment of the present invention.

FIGS. 7, 8, 9, 10, 11, 12, and 13 are diagrams for explaining the operation of the data configuration unit in the operation accelerator according to an embodiment of the present invention.

FIG. 14 is a flowchart illustrating the operation method of the operation accelerator according to an embodiment of the present invention.

### DETAILED DESCRIPTION

Hereinafter, embodiments of the present invention will be described in detail with reference to the accompanying drawings so that those skilled in the art can easily carry out the invention. However, the present invention may be implemented in various different forms and is not limited to the embodiments described herein. To clearly illustrate the invention in the drawings, unrelated parts are omitted, and similar reference numerals are used for similar elements throughout the specification.

Throughout the specification, when a part is referred to as being “connected” to another part, this includes both cases where they are “directly connected” and cases where they are “electrically connected” with another element in between. In addition, when a part is said to “include” a certain component, this does not exclude other components unless explicitly stated otherwise, and may include additional components.

In the present specification, the term “unit” may refer to a component implemented using hardware, software, or a combination of both. One unit may be implemented using two or more pieces of hardware, or two or more units may be implemented by a single piece of hardware. Moreover, the suffix “˜unit” is not limited to software or hardware only; it may also be embodied in an addressable storage medium or configured to be executed by one or more processors. Accordingly, by way of example, a “˜unit” may include software components, object-oriented software components, class components, and task components, as well as processes, functions, attributes, procedures, subroutines, segments of program code, drivers, firmware, microcode, circuits, data, databases, data structures, tables, arrays, and variables. The functionality provided within components and “˜units” may be integrated into fewer components and “˜units” or further divided into additional components and “˜units.” Furthermore, components and “˜units” may be implemented to be executed by one or more CPUs within a device.

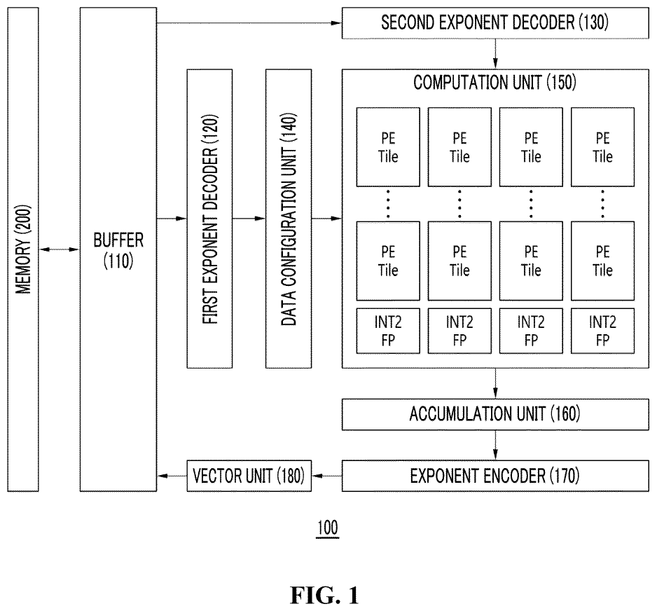

FIG. 1 illustrates an accelerator according to an embodiment of the present invention.

The accelerator (100) includes a buffer (110), a first exponent decoder (120), a second exponent decoder (130), a data configuration unit (140), a computation unit (150), a accumulation unit (160), an exponent encoder (170), and a vector unit (180). Notably, the first exponent decoder (120), second exponent decoder (130), data configuration unit (140), computation unit (150), accumulation unit (160), exponent encoder (170), and vector unit (180) may be implemented as software, hardware components such as FPGA (Field Programmable Gate Array), ASIC (Application Specific Integrated Circuit), or as various processors.

The buffer (110) stores input data—namely, activation values and weight data—received from the external memory (200). The buffer (110) also receives and stores data from the vector unit (180) to be output to the memory (200). The activation value refers to a value output from each layer in a deep neural network-based model and passed to the next layer, where it may serve as the input to that layer. Weight data refers to matrix values that constitute a trained artificial intelligence model or deep neural network, or to the weights in perceptrons simulating neurons. In particular, weights are computed by being multiplied by the activation values.

The first exponent decoder (120) determines whether the input data encoded with exponents represents an outlier based on the bias bit, and performs an alignment process by shifting the mantissa of the input data according to the bias bit.

The second exponent decoder (130) determines whether the exponent-encoded weight data represents an outlier based on the bias bit, and performs an alignment process by shifting the mantissa of the weight data according to the bias bit.

The detailed structure of the exponent-encoded input data and weight data, as well as the decoding process for these data, will be described in detail later.

The computation unit (150) performs multiplication and accumulation operations using integer arithmetic on the mantissa values output by the first exponent decoder (120) and the second exponent decoder (130). To this end, the computation unit (150) includes a plurality of PE (Processing Element) tiles arranged in a systolic array, each PE tile comprising a plurality of multipliers and an accumulator that sums the outputs of the multipliers. Each PE tile includes an integer multiplier and adder to perform multiplication operations between integer matrix data. For example, each PE may be implemented as a 2's complement integer processing unit and arranged in a systolic array to perform GEMM (General Matrix-Matrix Multiplication) operations. Since the integer arithmetic-based computation unit is conventional technology, a detailed description thereof is omitted.

Additionally, the computation unit (150) converts the integer-type data output by each PE tile into floating-point matrix data.

The accumulation unit (160) adds the floating-point values output by the computation unit (150) and outputs the result of the accumulation operation.

The exponent encoder (170) performs exponent encoding on the result that has been added via the accumulation unit (160), after the computation result output from the computation unit (150) is converted to a floating-point format. The exponent encoding process will be described separately.

The vector unit (180) transfers the accumulation result to the buffer (110). Additionally, the vector unit (180) can perform SIMD (Single Instruction Multiple Data) operations, such as dequantization calculations in the form of a*x+b. The final converted result may then be delivered to the memory (200) via the buffer (110).

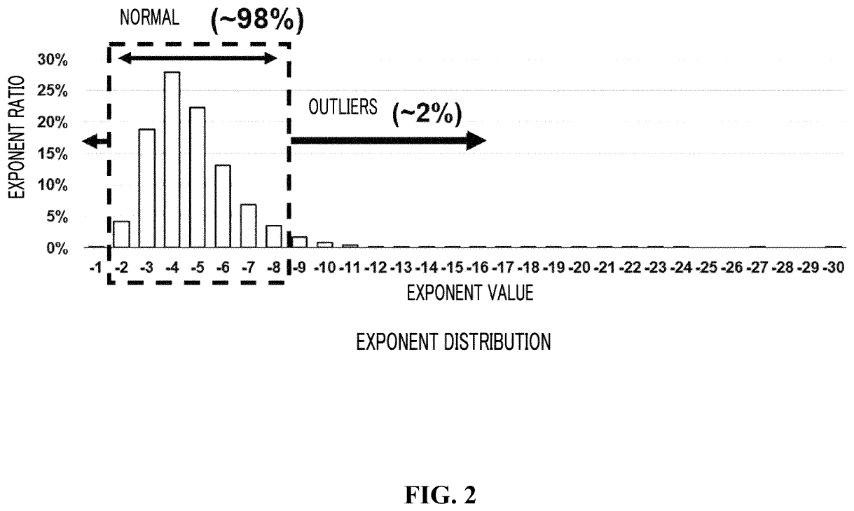

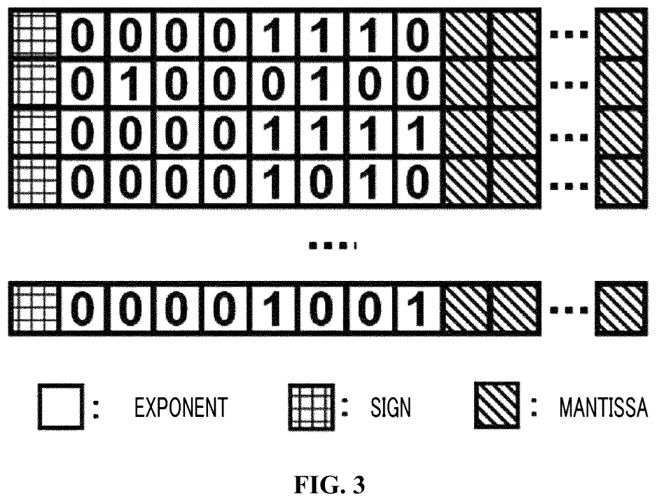

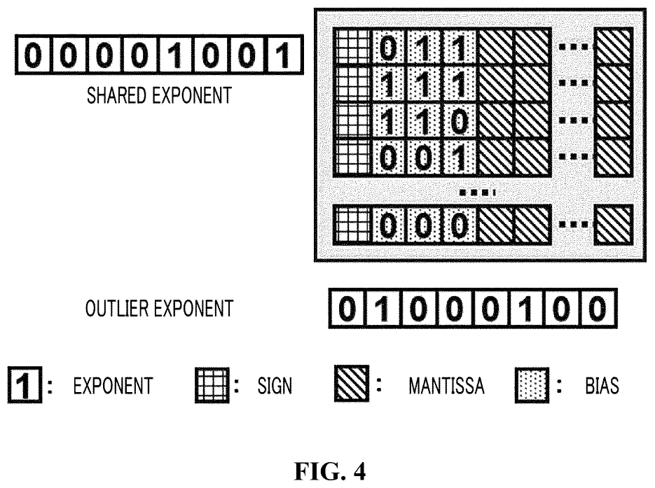

FIG. 2 is a diagram for explaining the distribution of normal values and outliers for weights and activation values in the present invention. FIGS. 3 and 4 are diagrams for explaining the exponent encoding process for each number in the present invention.

In the present invention, values with an exponent part within a predefined range are classified as normal values, and values with exponent parts outside this range are classified as outliers. The values that serve as the basis for this classification are referred to as reference values. For example, if the top seven exponent values (from −2 to −8) account for 98% of the total, they are classified as normal values, and the rest are considered outliers. Such a distribution of exponent parts can be identified based on the data used in the training process of a machine learning model, and reference values can be determined accordingly. In addition, the ratio of the distribution used to distinguish between normal values and outliers can be adjusted according to the designer's intention.

A floating-point number consists of a sign bit, exponent, and mantissa. In the case of BF16 (Brain Floating Point 16), the exponent is composed of 8 bits. If certain weight or activation values fall within the range of normal values, it is possible to represent the exponent part of each number using the difference from a shared exponent, and this difference is defined as the bias bits. For example, in FIG. 2, with −8 set as the shared exponent, the differences from the shared exponent for normal values ranging from −2 to −8 can be represented using 3 bias bits. Additionally, −2 becomes the maximum reference value distinguishing normal values from outliers, while −8 becomes the minimum reference value. When there are 7 reference values, the difference between the maximum and minimum reference values is 6.

FIG. 3 exemplarily illustrates numerical values before encoding according to the present invention, and FIG. 4 illustrates numerical values after encoding.

FIG. 3 shows the format of a 32-bit floating-point number composed of 1-bit sign, 8-bit exponent, and 23-bit mantissa. A shared exponent is set for multiple binary numbers, and the minimum value among a predefined set of exponents can be selected as the shared exponent. For example, the exponent representing −8 (00001001) can be set as the shared exponent, and the difference between each number's exponent and the shared exponent is defined as the bias bit. That is, the exponent value of −8 is encoded as −8+0 (bias bit 000), the exponent value of −6 is encoded as −8+2 (bias bit 010), and the exponent value of −2 is encoded as −8+6 (bias bit 110).

Through this method, each number is encoded in a form that combines the shared exponent and its corresponding bias bit. As shown in FIG. 4, a common shared exponent is used, and bias bits are determined for each number. In this way, the exponent part of each binary number can be represented using the shared exponent and bias bits, so it is possible to encode each number by storing only the sign bit, bias bit, and mantissa, without storing the entire exponent part of each floating-point number.

For outliers, since their exponent values fall outside the reference range, they cannot be represented as the sum of the shared exponent and bias bits, and the full-length exponent of the outlier must be stored separately. In this case, the bias bits for outliers are set to 111 so that the outlier can be identified using only the bias bits.

Such exponent encoding may be performed by the exponent encoder (170) described above or by an external encoder outside the accelerator (100). In the exponent encoding process, if the exponent of a floating-point number falls within the predefined reference range, the number is classified as a normal value, a bias bit representing the difference between the exponent and the shared exponent is calculated, and the number is expressed as a combination of the shared exponent, sign bit, bias bit, and mantissa. If the exponent falls outside the predefined reference range, the number is classified as an outlier, a reserved value is assigned as the bias bit, and the number is represented as a combination of the sign bit, reserved bias bit, and mantissa.

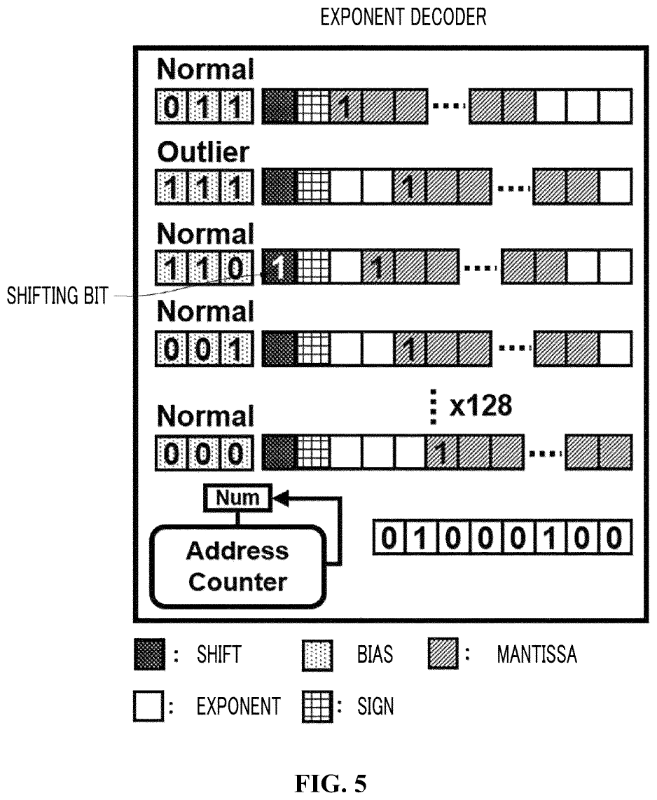

FIG. 5 illustrates a process for performing exponent decoding on exponent-encoded numbers according to one embodiment of the present invention.

To perform operations on exponent-encoded numbers using an integer computation unit with minimal floating-point support circuitry, a pre-alignment process is required in which the mantissa is shifted according to the bias bits before being passed to the computation unit.

The first exponent decoder (120) performs a pre-alignment by left-shifting the mantissa of the input data by the value of the bias bit when the exponent-encoded input data is a normal value, and performs no pre-alignment if the input data is an outlier. Similarly, the second exponent decoder (130) performs a pre-alignment by left-shifting the mantissa of the weight data by the value of the bias bit when the exponent-encoded weight data is a normal value, and performs no pre-alignment if the weight data is an outlier.

In the exponent decoding process, the mantissa of each floating-point number is left-shifted according to the corresponding bias bits during pre-alignment. More specifically, the most significant bit (MSB) of the bias bit is not used for shifting; only the remaining two bits are used to determine the left shift amount. For example, if the bias bit is 000, no shift is performed; if it is 001, a left shift of 1 is performed; and if it is 011, a left shift of 3 is performed. When the bias bit is 110, since the MSB is ignored during pre-alignment, the result is the same as 010, resulting in a left shift of 2. During pre-alignment, all values in the original mantissa are preserved without loss. The aligned values are then passed to the integer computation unit configured as a systolic array for processing.

If the bias bit is ‘111’, which indicates an outlier, then the corresponding mantissa is considered that of an outlier and no pre-alignment is performed.

In some embodiments, it is also possible to use the most significant bit (MSB) of the bias bit during pre-alignment. When the bias bit is 3 bits, incorporating the MSB increases the shift range, and may require up to 4 bits of alignment for the mantissa. Therefore, compared to embodiments that do not use the MSB for pre-alignment, the final aligned integer result may have a longer bit width, which could reduce the efficiency of the computation unit.

Using the pre-aligned mantissa as described, integer operations are performed, and after computation, the shared exponent or the outlier's exponent is reapplied to convert the result back into a floating-point number.

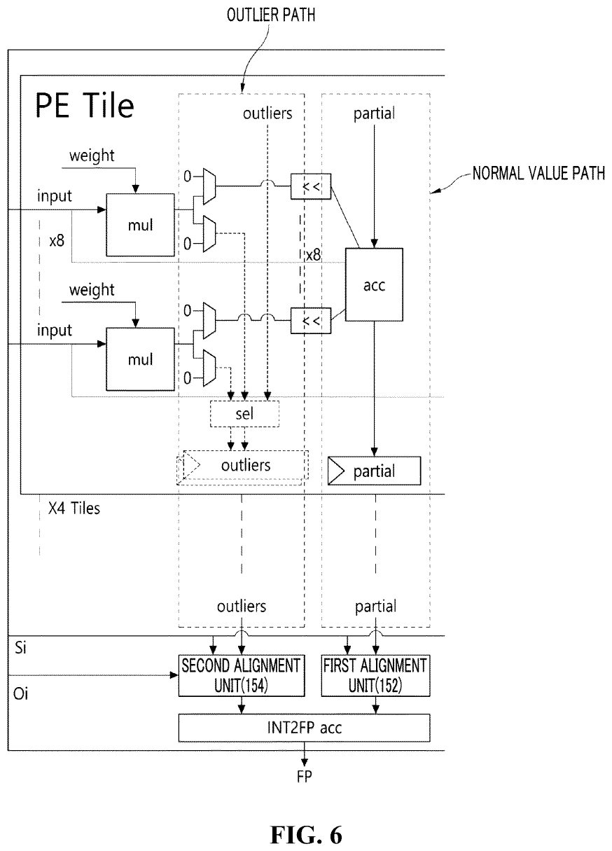

FIG. 6 illustrates the detailed configuration of the computation unit according to an embodiment of the present invention.

The computation unit includes an array of multiple PE (processing element) tiles that perform multiplication and accumulation operations on integer data. Each PE tile includes multiple multipliers (mul) that multiply weights and input data, and an accumulator (acc) that accumulates the outputs from the multipliers. A single PE tile can perform multiple multiply-accumulate operations simultaneously using multiple multipliers and an accumulator. Specifically, multiplication operations such as regular×regular, regular×outlier, and outlier×outlier can be performed using the weight data and activation values passed from the exponent decoders (120, 130).

Each PE tile includes a regular path through which the results of multiplications between normal values and their partial sums are transmitted. It also includes an outlier path through which results from regular×outlier and outlier×outlier multiplications are transmitted. Additionally, vertically adjacent PE tiles can share outlier-based results and normal value-based partial sums via the outlier and regular paths, respectively.

As previously described, whether a value is an outlier can be determined by the exponent decoder using the bias bit, and if it is an outlier, a flag indicating the outlier status is delivered to the computation unit (150). Each PE tile can also identify whether the value is an outlier using this flag. Based on this information, a multiplexer attached to each multiplier output routes multiplication results involving outliers through the outlier path, and routes multiplication results between normal values through the regular path.

Meanwhile, in the case of multiplications between an outlier and a normal value or between two outliers, alignment is required for the outlier. These results are delivered via the outlier path to the second alignment unit (154), which performs post-alignment based on the exponent of the outlier. The results of multiplications between normal values are summed with partial results via the accumulator (acc), and are delivered to the first alignment unit (152) via the regular path.

The values post-aligned through the first alignment unit (152) and the second alignment unit (154) are then converted back into floating-point format. The first alignment unit (152) applies the shared exponent (Si) to the accumulated result to perform alignment for converting the accumulated result into a floating-point value. Additionally, the second alignment unit (154) applies the outlier exponent (Oi) to the accumulated result to perform alignment for converting the outlier computation result into a floating-point value. More specifically, the sizes of the shared exponent (Si) and the outlier exponent (Oi) are compared to determine the larger value (E_max). Then, the difference between E_max and the shared exponent (E_max−Si) is delivered to the first alignment unit (152), while the difference between E_max and the outlier exponent (E_max−Oi) is delivered to the second alignment unit (154). The first and second alignment units can then align the computation results based on the delivered values. For example, if the shared exponent (Si) is larger than the outlier exponent (Oi), a value of 0 is delivered to the first alignment unit (152), and the difference between the shared and outlier exponents is delivered to the second alignment unit (154). Conversely, if the shared exponent (Si) is smaller than the outlier exponent (Oi), a value of 0 is delivered to the second alignment unit (154), and the difference is delivered to the first alignment unit (152). The subsequent process of applying these values to the mantissa of the computation result to perform the floating-point conversion is substantially the same as the conventional floating-point conversion process, and thus a detailed description is omitted. Each value aligned by the alignment units (152, 154) is converted into a single floating-point result through INT2FP.

Meanwhile, in the computation unit (150), processing of the shifting bits that were not aligned by the exponent decoders may occur before the accumulation operation is performed on the normal values. That is, the most significant bit of the previously mentioned bias bits may be used as a shifting bit. Depending on the combination of the shifting bits from the weight and activation values, the result of the multiplication operation may be shifted by 0, 4, or 8 bits. For example, by multiplying the sum of the shifting bits of the weight and activation value by 4, the shift amount can be adjusted and then applied during the accumulation operation.

As a result, the integer values transmitted intact without loss of information from each of the exponent decoders (120, 130) are processed through integer computation in the computation unit (150), and the results for normal values and outliers are separately aligned and then converted into floating-point format.

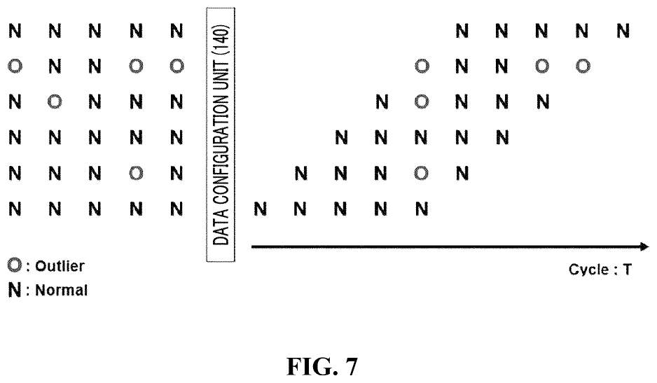

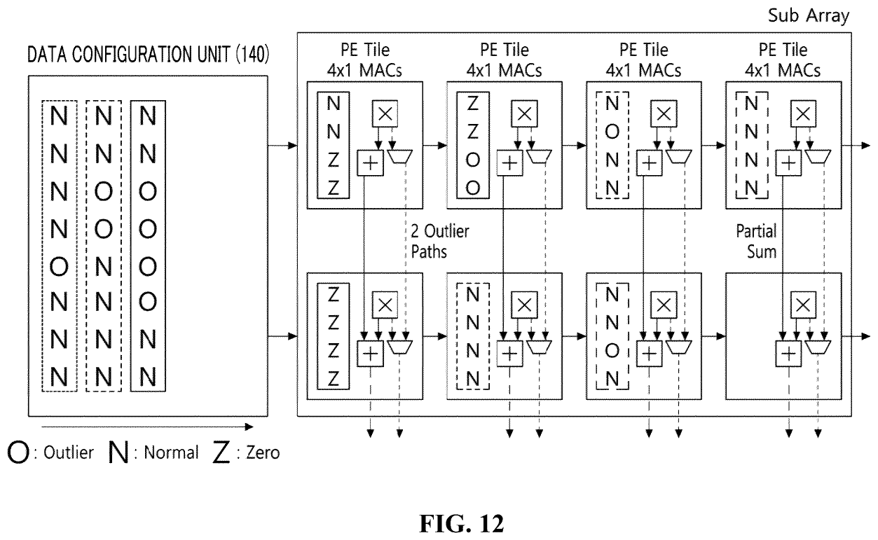

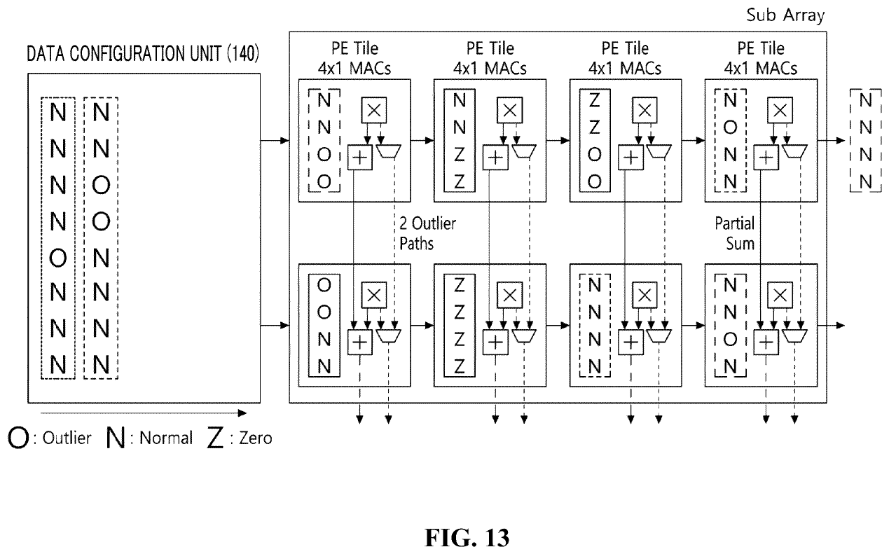

FIGS. 7 through 13 illustrate the operation of the data configuration unit of the computation accelerator according to an embodiment of the present invention.

As shown in FIG. 7, the data configuration unit (140) performs an operation that adds delay to each row, considering that the computation unit (150) has a systolic array structure. That is, the computation unit (150) with a systolic array structure performs a multiplication operation on an M*N matrix, and since the input data to each row or column is structured to be delayed by one cycle per row or column, the data configuration unit (140) outputs the data such that it is set with a one-cycle delay for each row. For example, the data placed in the second row is delivered to the computation unit (150) one cycle later than the data placed in the first row.

In addition to the basic operation described above, the data configuration unit (140) performs additional operations to account for outliers. As previously described, the result of a multiplication involving outliers is not accumulated with partial sums but is instead passed to the lower PE tiles via the outlier path. However, since the number of outlier paths is limited, if the number of outlier results exceeds the number of outlier paths, simultaneous transmission of all outliers becomes impossible. To resolve this, the data configuration unit (140) performs a zero-insertion operation for data vectors that contain more outliers than a given threshold. In this process, the data vector is partially segmented and zeros are inserted, so that one data vector is distributed over multiple cycles to the systolic array.

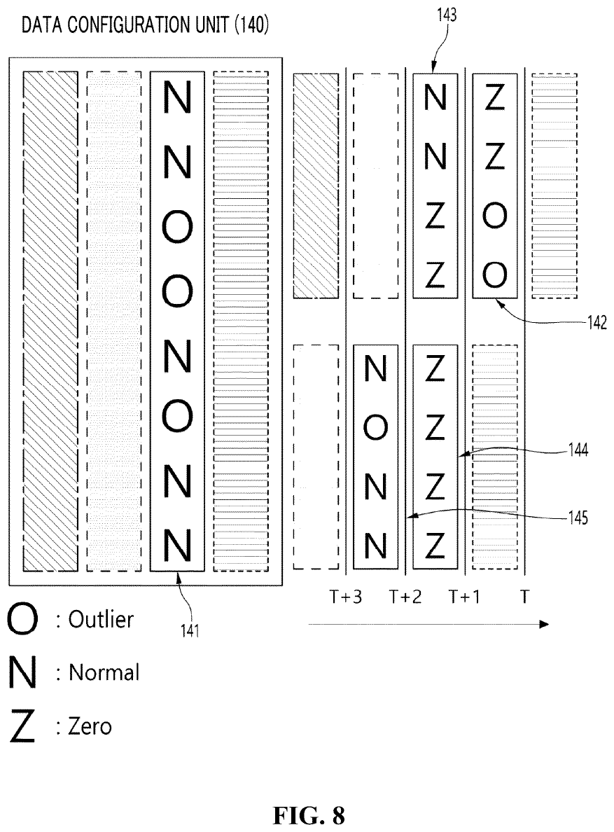

Assuming that each PE tile contains two outlier paths, as shown in FIG. 8, each PE tile can deliver at most two outlier multiplication results to the lower PE tile in a single cycle. Therefore, to process an activation value vector that contains three outliers, the vector is divided and zero-insertion is performed so that the processing is distributed over two cycles. For example, since data vector (141) contains three outliers, it is split to generate segmented data vectors (142-145), each of which contains outliers below the threshold. To ensure that the outlier-containing segmented data vectors (142, 145) are processed in different cycles, they are temporally separated, and in the cycles in between, segmented data vectors (143, 144) with appropriate zero-insertion are placed in the empty slots.

Through this method, even when the number of outliers within the vector increases significantly, they can all be processed over multiple cycles, and the result values can still be maintained in floating-point format.

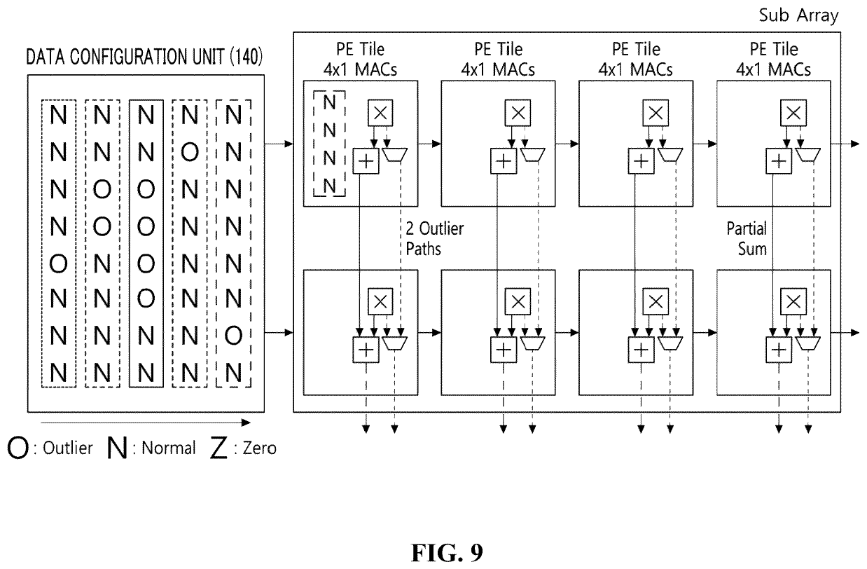

FIGS. 9 through 13 illustrate in more detail how the data configuration unit transfers data to the computation unit. The data configuration unit (140) transmits data vectors for a total of five columns, and the transmission process is shown sequentially. It is assumed that each PE tile of the computation unit (150) includes two outlier paths.

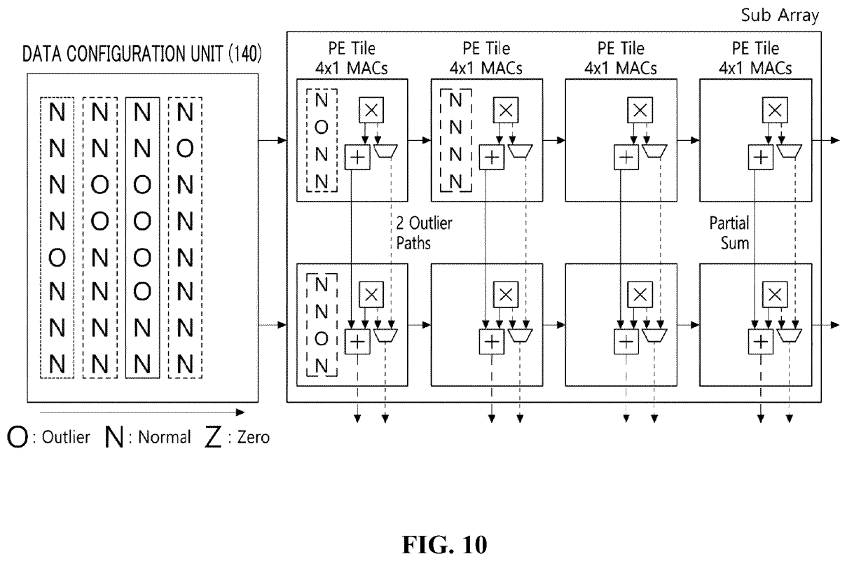

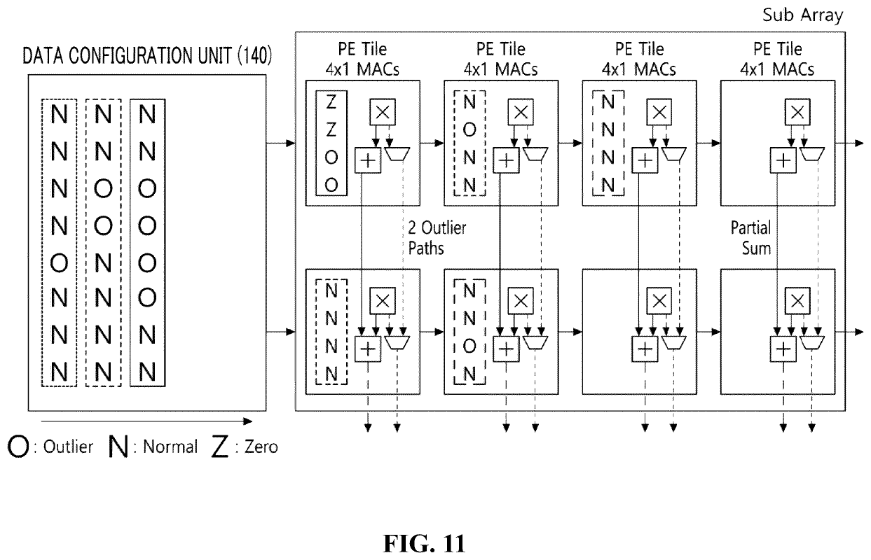

In FIGS. 9 and 10, since the vectors in the first and second columns each contain only one outlier, they are transmitted according to normal cycles without requiring zero-insertion. However, as shown in FIGS. 11, 12, and 13, the vector in the third column contains three outliers, so as described in FIG. 8, the zero-insertion operation is performed, and the vector is divided and processed over multiple cycles. That is, the third column vector is divided such that each segmented vector includes only outliers below the threshold, and additional data vectors with zero-insertion are placed in between so that the segmented vectors are processed in temporally separated cycles.

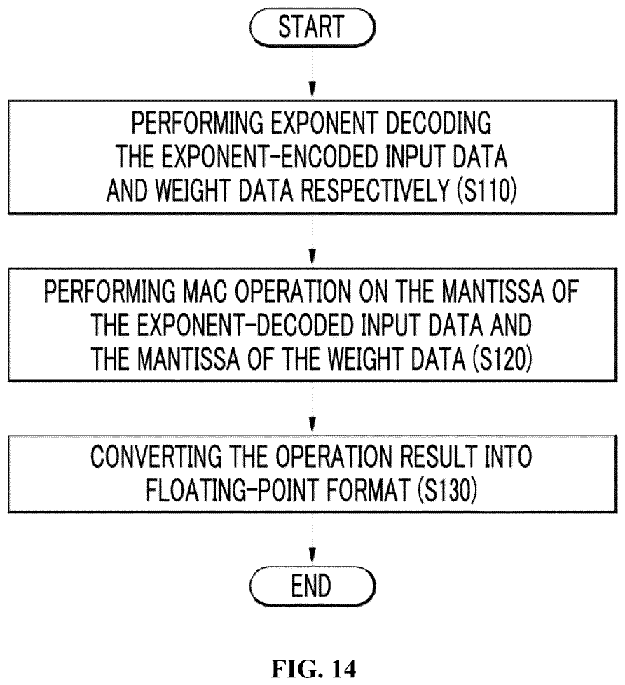

FIG. 14 illustrates a flowchart of the operation method of the computation accelerator according to an embodiment of the present invention.

First, exponent decoding is performed on the exponent-encoded input data and weight data, respectively (S110).

More specifically, a first exponent decoding is performed that identifies whether the exponent-encoded input data is an outlier based on its bias bits, and performs a pre-alignment by shifting the mantissa of the input data according to the bias bits. Additionally, a second exponent decoding is performed that identifies whether the exponent-encoded weight data is an outlier based on its bias bits, and performs a pre-alignment by shifting the mantissa of the weight data according to the bias bits.

It is noted that the exponent encoding process includes: when the exponent part of a floating-point number falls within a predetermined reference range, classifying the number as a normal value, calculating bias bits representing the difference between the number's exponent and a shared exponent, and outputting an exponent-encoded number composed of the shared exponent, sign bit, bias bits, and mantissa. In this case, the shared exponent corresponds to the minimum exponent within the reference range. Furthermore, if the exponent part does not fall within the reference range, the process includes classifying the number as an outlier, assigning a reserved value as the bias bits, and outputting an exponent-encoded number composed of the sign bit, the reserved bias bits, and the mantissa.

Next, a MAC (Multiply-Accumulate) operation is performed on the mantissa of the exponent-decoded input data and the mantissa of the weight data (S120).

For multiplication between normal values, integer operations can be performed on the mantissas that have been pre-aligned through exponent decoding. In the case of multiplication involving outliers, integer operations are performed using the unmodified mantissa of the outlier.

Next, the operation results are converted into floating-point format (S130). The results of the integer operations are converted to floating-point format by applying the shared exponent or the outlier exponent. For normal values, the shared exponent is applied; for outliers, the outlier exponent is applied to perform the floating-point conversion.

After this process is completed, the final result of the multiplication operation is output and may be transferred to memory (200) through the vector unit (180) and buffer (110). During this process, the floating-point result may be exponent-encoded through the exponent encoder (170) and then passed to the vector unit (180), etc.

The method according to an embodiment of the present invention may also be implemented in the form of a computer-readable medium including executable instructions such as program modules executed by a computer. A computer-readable medium may be any available medium accessible by a computer and includes both volatile and non-volatile media, and both removable and non-removable media. In addition, the computer-readable medium may include computer storage media. The computer storage media include both volatile and non-volatile, removable and non-removable media implemented in any method or technology for storage of information such as computer-readable instructions, data structures, program modules, or other data.

Although the method and system of the present invention have been described with reference to specific embodiments, some or all of their components or operations may be implemented using a computer system with a general-purpose hardware architecture.

The above description of the present invention is illustrative, and those skilled in the art will understand that various changes and modifications can be made without departing from the spirit or essential characteristics of the present invention. Therefore, the embodiments described above should be understood as exemplary in all respects and not as restrictive. For example, each component described as being implemented in a single form may be implemented in a distributed form, and likewise, components described as being distributed may be implemented in a combined form.

The scope of the present invention should be indicated by the claims rather than the foregoing detailed description, and all modifications or variations derived from the meaning and scope of the claims and their equivalents should be interpreted as being within the scope of the present invention.

### DESCRIPTION OF REFERENCE SIGNS

100: Operation Accelerator
110: Buffer
120: First Exponent Decoder
130: Second Exponent Decoder
140: Data Configuration Unit
150: Computation unit
160: Accumulation Unit
170: Exponent Encoder
180: Vector Unit
200: Memory

What is claimed is:

1. An accelerator for processing floating point operations using an integer operator, comprising:
a first exponent decoder configured to determine whether an input data encoded with an exponent is an outlier based on a bias bit thereof, and to perform pre-alignment processing by shifting a mantissa of the input data according to the bias bit;
a second exponent decoder configured to determine whether a weight data encoded with an exponent is an outlier based on a bias bit thereof, and to perform pre-alignment processing by shifting a mantissa of the weight data according to the bias bit; and
a computation unit configured to perform multiplication and accumulation operations in integer arithmetic on the mantissa of the input data output from the first exponent decoder and the mantissa of the weight data output from the second exponent decoder.

2. The accelerator according to claim 1,
wherein the exponent-encoded input data or weight data is:
a combination of a shared exponent, a sign bit, a bias bit indicating a difference between the exponent of the number and the shared exponent, and a mantissa, when the exponent of the floating point number falls within a predetermined reference range and is classified as a normal value; and
a combination of the exponent of the number, a sign bit, a bias bit assigned with a reserved value, and a mantissa, when the exponent of the floating point number falls outside the predetermined reference range and is classified as an outlier,
wherein the shared exponent corresponds to the minimum value among the exponents included in the reference range.

3. The accelerator according to claim 2,
wherein the first exponent decoder
performs a pre-alignment by left-shifting the mantissa of the input data by a value of the bias bit, when the exponent-encoded input data is a normal value, and
does not perform pre-alignment when the exponent-encoded input data is an outlier, and
the second exponent decoder
performs a pre-alignment by left-shifting the mantissa of the weight data by a value of the bias bit, when the exponent-encoded weight data is a normal value, and
does not perform pre-alignment when the exponent-encoded weight data is an outlier.

4. The accelerator according to claim 3,
wherein the first exponent decoder and the second exponent decoder
perform the pre-alignment based on the remaining bits of the bias bit, excluding the most significant bit of the bias bit from the pre-alignment.

5. The accelerator according to claim 1,
further comprising a data configuration unit that adjusts the cycle of data output from the first exponent decoder and transmits it to the computation unit,
wherein the data configuration unit, when a data vector including outliers contains more outliers than a threshold, performs a zero insertion operation by inserting zeros into the data vector and splits the data vector into multiple cycles before transmitting it to the computation unit.

6. The accelerator according to claim 1,
wherein the computation unit includes a plurality of PE tiles arranged in an array form,
each PE tile includes a plurality of multipliers and an accumulator that sums the outputs of the multipliers,
and each PE tile includes a normal value path through which multiplication results and partial sums of normal values are transmitted,
and an outlier path through which multiplication results of normal values and outliers and multiplication results of outliers and outliers are transmitted.

7. The accelerator according to claim 1,
further comprising an exponent encoder that performs exponent encoding after the operation result output from the computation unit is converted into a floating-point format, wherein the exponent encoder:
if the exponent part of a floating-point number falls within a predetermined reference range, classifies the number as a normal value, calculates a bias bit representing the difference between the exponent part and a shared exponent, and outputs an encoding result consisting of the shared exponent, sign bit, the bias bit, and mantissa for the number classified as a normal value; and
if the exponent part of the floating-point number does not fall within the predetermined reference range, classifies the number as an outlier, assigns a reserved value as the bias bit, and outputs an encoding result consisting of the sign bit, the bias bit assigned with the reserved value, and mantissa for the number classified as an outlier, wherein the shared exponent corresponds to the minimum value among the exponents included in the reference range.

8. The accelerator according to claim 2,
wherein the computation unit converts each operation result into a floating-point number by applying the exponent and sign,
and if the exponent-encoded input data or weight data is encoded using the shared exponent,
the shared exponent is applied to convert the result into a floating-point number.

9. A method of exponent encoding a number in floating-point format, the method comprising:
(a) classifying the number as a normal value if the exponent part of the floating-point number falls within a predetermined reference range, and calculating a bias bit representing the difference between the exponent part of the number and a shared exponent; and
(b) outputting, as an encoding result, a combination of the shared exponent, sign bit, the bias bit, and mantissa for the number classified as the normal value,
wherein the shared exponent corresponds to the minimum value among the exponents included in the reference range.

10. The method of claim 9,
(c) classifying the number as an outlier if the exponent part of the floating-point number does not fall within the predetermined reference range, and assigning a reserved value to the bias bit; and
(d) outputting, as an encoding result, a combination of the sign bit, the bias bit assigned with the reserved value, and the mantissa for the number classified as the outlier.

11. In an operation method of an accelerator for processing floating-point operations using an integer operator,
(a) performing a first exponent decoding process in which an outlier is identified based on a bias bit of exponent-encoded input data, and a mantissa of the input data is shifted according to the bias bit;
(b) performing a second exponent decoding process in which an outlier is identified based on a bias bit of exponent-encoded weight data, and a mantissa of the weight data is shifted according to the bias bit; and
(c) performing a multiplication and accumulation operation based on integer operations on the mantissa of the input data output by the first exponent decoding and the mantissa of the weight data output by the second exponent decoding.

12. The method of claim 11,
wherein the exponent-encoded input data or weight data is a combination of a shared exponent, a sign bit, a bias bit indicating a difference between the exponent of the number and the shared exponent, and a mantissa, if the exponent of the floating-point number falls within a predetermined reference range,
and a combination of the exponent of the number, a sign bit, a bias bit assigned with a reserved value, and a mantissa, if the exponent of the floating-point number does not fall within the predetermined reference range,
wherein the shared exponent corresponds to a minimum exponent among the reference values.

13. The method of claim 12,
wherein the first exponent decoding process includes performing a pre-alignment by left-shifting the mantissa of the input data by the value of the bias bit, if the exponent-encoded input data is classified as a normal value,
and not performing the pre-alignment on the input data, if the exponent-encoded input data is classified as an outlier,
and the second exponent decoding process includes performing a pre-alignment by left-shifting the mantissa of the weight data by the value of the bias bit, if the exponent-encoded weight data is classified as a normal value,
and not performing the pre-alignment on the weight data, if the exponent-encoded weight data is classified as an outlier.

14. The method of claim 13,
wherein in the first exponent decoding process and the second exponent decoding process,
a most significant bit of the bias bit is not used for the pre-alignment,
and the pre-alignment is performed based on the remaining bits of the bias bit.

15. The method of claim 11,
further comprising, before performing the step (c),
a data configuration step of adjusting the cycle of the output from the first exponent decoding step and transmitting the data to a computation unit,
wherein in the data configuration step, if a data vector including outliers contains more outliers than a threshold, the data vector is divided into multiple cycles with a zero-insertion operation that inserts zeros into the vector, and is then transmitted to the c.

16. The method of claim 11,
further comprising a step of applying an exponent and sign to each operation result of the step (c) to convert the operation result into a floating-point number,
wherein, if the exponent-encoded input data or weight data is encoded using a shared exponent, the shared exponent is applied to convert the result into a floating-point number.

17. The method of claim 16,
further comprising a step of performing exponent encoding on the number after the operation result is converted into a floating-point format,
wherein, if the exponent of the floating-point number is within a predetermined reference range, the number is classified as a normal value, a bias bit representing the difference between the exponent and the shared exponent is calculated, and the number classified as a normal value is output as an encoded result consisting of the shared exponent, sign bit, bias bit, and mantissa,
and if the exponent of the floating-point number is not within the predetermined reference range, the number is classified as an outlier, a reserved value is assigned to the bias bit, and the number classified as an outlier is output as an encoded result consisting of the sign bit, the reserved bias bit, and the mantissa,
wherein the shared exponent corresponds to the minimum exponent among those within the range of the reference values.

18. A non-transitory recording medium storing a computer program for executing the method according to claim 9.
